(19) United States
(12) Patent Application Publication
(10) Pub. No.: US 2024/0243425 A1
(43) Pub. Date: Jul. 18, 2024

(54) DEVICE MODULE AND CHANGE MEMBER-EQUIPPED POWER STORAGE DEVICE

(71) Applicant: Prime Planet Energy & Solutions, Inc., Tokyo (JP)

(72) Inventor: Yasunori BABA, Kobe-shi (JP)

(21) Appl. No.: 18/510,655

(22) Filed: Nov. 16, 2023

(30) Foreign Application Priority Data
Jan. 17, 2023 (JP) 2023-005003

(51) Int. Cl. H01M 50/342; H01M 50/119

(52) U.S. Cl. CPC H01M 50/3425; H01M 50/119; H01M 2200/20

(57) ABSTRACT

A device module includes a power storage device including a safety valve, a structure integrated with the power storage device, the structure including an ejection direction portion located in an ejection direction in which ejection is ejected out through the safety valve when the safety valve opens, and a direction change part located between the safety valve and the ejection direction portion, for changing an advancing direction of at least a part of the ejection ejected in the ejection direction from the safety valve.

### CROSS-REFERENCE TO RELATED APPLICATIONS

This application is based upon and claims the benefit of priority to Japanese Patent Application No. 2023-005003 filed on Jan. 17, 2023, the entire contents of which are incorporated herein by reference.

### BACKGROUND

### Technical field

The present disclosure relates to a device module and a change member-equipped power storage device.

### Related Art

Conventionally, one or more secondary batteries are housed in a structure such as a housing to provide a battery module, and this battery module is used in various kinds of equipment such as an automobile in some cases.

Such a secondary battery is provided with a safety valve. If an abnormality occurs in the secondary battery, increasing the internal pressure of the secondary battery, the safety valve is activated to eject gas and the like to reduce the internal pressure. However, when the safety valve opens, high-temperature ejection (i.e., high-temperature ejected material) may be ejected.

WO2018/079423 A1 discloses a rectangular-shaped secondary battery in which a shielding member made of metal is placed between a safety valve (a gas discharge valve) and an electrode body, at a position opposed to the safety valve. According to this secondary battery, when the safety valve is activated high-temperature molten materials, sparks, and others can be prevented from being ejected out of a battery case through the safety valve.

### SUMMARY

### Technical Problems

However, even when the secondary battery described in WO2018/079423 is used, ejection such as high-temperature gas cannot be prevented from being ejected out through the opened safety valve.

Ejection ejected out through the opened safety valve tends to be ejected in a beam shape concentratedly in an ejection direction. This may cause some following defects. For example, when a concentrated stream of high-temperature ejection continues to impinge on a portion, of a structure such as a housing included in a module, located in the ejection direction, a hole is made in that portion, which may cause the ejection to be ejected out of the module through the hole or thermally deform that portion and its surrounding area.

The present disclosure has been made in view of such circumstances, and provides: a device module configured to suppress occurrence of defects in a structure included in a device module, even when an abnormality occurs in a power storage device included in the device module and a safety valve opens; and a change member-equipped power storage device for use in such a device module.

### Means of Solving the Problems

(1) To achieve the above purpose, one aspect of the present disclosure provides a device module comprising: a power storage device including a safety valve; and a structure integrated with the power storage device, the structure including an ejection direction portion located in an ejection direction in which ejection is ejected out through the safety valve when the safety valve opens, wherein the device module further comprises a direction change part, located between the safety valve and the ejection direction portion, for changing an advancing direction of at least a part of the ejection ejected in the ejection direction from the safety valve.

The device module includes the direction change part between the safety valve and the ejection direction portion of the structure. Thus, when the safety valve opens, the advancing direction of a part or all of the ejection such as high-temperature gas ejected toward the ejection direction from the safety valve is changed, whereby the ejection can be suppressed or prevented from concentratedly impinging on the ejection direction portion. This configuration can suppress the occurrence of defects that a hole is made in the ejection direction portion by the ejection, the ejection is ejected out through the hole, or a member forming the ejection direction portion is thermally deformed.

Examples of the power storage device may include secondary batteries such as a lithium-ion secondary battery, and capacitors such as a lithium ion capacitor.

The safety valve may include a non-return safety valve which opens by breaking or rupturing a valve member when the internal pressure of the power storage device exceeds a valve opening pressure, and a return safety valve which closes when gas is discharged to reduce the internal pressure.

The structure is a member that is integrated with one or more power storage devices to form a device module together with the power storage devices. Examples of the structure may include a housing for housing the power storage device, a cover, and a discharge path forming member that forms a discharge path for discharging ejected gas to the outside, in the device module.

The ejection direction portion is a portion, of the structure, located in the ejection direction in which the ejection is ejected out through the safety valve.

The direction change part may be located between the safety valve and the ejection direction portion in the device module so as to be able to disperse the advancing direction of at least a part of (a part or all of) the ejection ejected in the ejection direction. Thus, for example, a change member forming the direction change part may be provided separately from the power storage device and the structure. In contrast, the change member forming the direction change part may also be provided integrally with the power storage device. In the contrary, the change member forming the direction change part may also be provided integrally with a member forming the structure such as a member forming the ejection direction portion. In the device module, one dispersion part may be provided per power storage device, or one dispersion part may be configured for the safety valves of the power storage devices.

(2) In the above-described device module in (1), the direction change part may be a dispersion part for dispersing the advancing direction of the ejection.

In the above-described device module, the direction change part provided between the safety valve and the ejection direction portion is the dispersion part. Thus, the advancing direction of at least a part of the ejection ejected out through a valve opening position of the safety valve is changed and dispersed. Thus, the ejection can be suppressed from concentratedly impinging on the ejection direction portion, and the ejection is dispersed while advancing, so that thermal influence on a portion on which the ejection has impinged can be further reduced. Therefore, occurrence of defects that a hole is made in a member forming the ejection direction portion by the ejection, the ejection is ejected outside through the hole, or the member forming the ejection direction portion is thermally deformed, can be reliably suppressed.

(3) In the above-described device module in (2), further, the dispersion part may include a multipath forming member for dividedly guiding the ejection ejected out through the safety valve into a plurality of advancing directions.

In the above-described device module, the dispersion part includes a multipath forming member, and thus the advancing direction of the ejection can be reliably dispersed.

(4) In the above-described device module in one of (1) to (3), at least a portion, of the direction change part, on which the ejection impinges, may be made of a heat-resistant material capable of enduring the temperature of the ejection.

In the device module, at least a portion, of the direction change part, on which the ejection impinges, is made of a heat-resistant material, and thus the advancing direction of the ejection can continue to be reliably changed even if the ejected ejection impinges on the direction change part.

The heat-resistant material usable as above may be selected considering the temperature and estimated ejecting duration of the ejection and may include for example a material having a melting point of 600° C. or higher, for example, steel materials such as carbon steel and stainless steel, metal materials such as iron, copper, nickel, titanium, and alloys thereof, and ceramic materials such as alumina.

(5) Moreover, in the above-described device module in one of (1) to (4), the direction change part may be provided integrally with the power storage device in a form of covering the safety valve.

In the device module, the direction change part is provided integrally with the power storage device, and thus the direction change part can always be placed at an appropriate position in relation to the power storage device and the safety valve.

Examples of a method for integrally providing the direction change part with the power storage device include a method for fixing the change member forming the direction change part to the case of the power storage device by welding, adhesion, engaging, or the like.

(6) Alternatively, in the above-described device module in one of (1) to (4), the direction change part may be provided integrally with the structure.

In the device module, the direction change part is provided integrally with the structure, and thus the direction change part can always be placed at an appropriate position in relation to the ejection direction portion of the structure.

(7) Furthermore, the above-described device module in one of (1) to (6) may be configured such that the power storage device includes a metal case forming a case wall part, the safety valve is a rupture safety valve formed of a thin part that is a part of the case wall part and configured to open when the thin part ruptures, and the ejection direction portion is an ejection direction confronting part that confronts the safety valve.

In the device module, the safety valve is a rupture safety valve, and the ejection direction portion is an ejection direction confronting part. That is, since the ejection direction confronting part confronts the rupture safety valve, when no direction change part is provided, the ejection direction is approximately perpendicular to the ejection direction confronting part, and the ejection ejected out through the safety valve impinges on the ejection direction confronting part head-on, so that defects such as a hole made in the ejection direction confronting part are likely to occur.

In contrast, in the present disclosure, the direction change part is provided, which can reduce or eliminate the ejection which impinges on the ejection direction confronting part, and thus suppress or prevent occurrence of defects such as a hole which is generated in the ejection direction confronting part.

(8) Another aspect of the present disclosure provides a change member-equipped power storage device comprising: a power storage device including a safety valve; and a change member integrally provided with the power storage device, the change member covering the safety valve and forming a direction change part for changing an advancing direction of at least a part of ejection ejected to an ejection direction from the safety valve when the safety valve opens.

In the change member-equipped power storage device, the change member is provided integrally with the power storage device. Thus, when the safety valve opens, the advancing direction of a part or all of the ejection such as high-temperature gas ejected toward the ejection direction from the safety valve is changed, and the ejection can be suppressed or prevented from concentratedly advancing in the ejection direction.

Therefore, when the change member-equipped power storage device is assembled with the structure to form the device module or the like, this configuration can suppress occurrence of defects that the ejection concentratedly impinges on a member of the structure, which forms the ejection direction portion located in the ejection direction, causing a hole in the member, the ejection is ejected outside through this hole, or the member forming the ejection direction portion is thermally deformed.

Furthermore, the change member is provided integrally with the power storage device in the change member-equipped power storage device, and thus the direction change part can always be placed at an appropriate position in relation to the power storage device and the safety valve.

(9) In the above-described change member-equipped power storage device in (8), the direction change part may be a dispersion part for dispersing the advancing direction of the ejection.

The direction change part is the dispersion part in the change member-equipped power storage device. This configuration can suppress the ejection from concentratedly advancing in the ejection direction and additionally disperse the ejection while advancing, so that thermal influence on a portion on which the ejection has impinged can be further reduced. This can reliably suppress the occurrence of defects that a hole is made in a member on which the ejection has impinged, the ejection is ejected outside through the hole, or the member forming the ejection direction portion is thermally deformed.

(10) In the above-described change member-equipped power storage device in (9), the dispersion part may include a multipath forming member for dividedly guiding the ejection ejected out through the safety valve into a plurality of advancing directions.

In the change member-equipped power storage device, since the dispersion part includes the multipath forming member, the advancing direction of the ejection can be reliably dispersed.

(11) In the above-described change member-equipped power storage device in one of (8) to (10), at least a portion, of the change member, on which the ejection impinges, may be made of a heat-resistant material capable of enduring the temperature of the ejection.

In the change member-equipped power storage device, at least a portion of the change member, on which the ejection impinges, is made of a heat-resistant material. Thus, even if the ejected ejection impinges on the change member, the advancing direction of the ejection can be changed continuously reliably.

### BRIEF DESCRIPTION OF THE DRAWINGS

FIG. 1 is a perspective view of a change member-equipped battery according to an embodiment;

FIG. 2 is a perspective view of a dispersion member according to the embodiment;

FIG. 3 is a partially enlarged cross-sectional view of the dispersion member and its surrounding area in the change member-equipped battery according to the embodiment;

FIG. 4 is a perspective view of a battery module according to the embodiment and first to sixth modifications;

FIG. 5 is a perspective view of the battery module in which a top plate is removed, according to the embodiment and the first to sixth modifications;

FIG. 6 is an explanatory view showing a state in which a nail penetration test is performed on the change member-equipped battery according to the embodiment;

FIG. 7 is an explanatory view showing a state in which ejection is advancing when a safety valve opens in a battery including no change member, according to a comparative embodiment;

FIG. 8 is an explanatory view showing a state in which ejection is advancing when a safety valve opens in the change member-equipped battery according to the embodiment;

FIG. 9 is a partially enlarged cross-sectional view of a dispersion member and its surrounding area in a change member-equipped battery according to the first modification;

FIG. 10 is a partially enlarged cross-sectional view of a dispersion member and its surrounding area in a change member-equipped battery according to the second modification;

FIG. 11 is a partially enlarged cross-sectional view of a dispersion member and its surrounding area in a change member-equipped battery according to the third modification;

FIG. 12 is a partially enlarged cross-sectional view of a dispersion member and its surrounding area in a change member-equipped battery according to the fourth modification;

FIG. 13 is a partially enlarged cross-sectional view of a dispersion member and its surrounding area in a change member-equipped battery according to the fifth modification;

FIG. 14 is a partially enlarged cross-sectional view of a dispersion member and its surrounding area in a change member-equipped battery according to the sixth modification;

FIG. 15 is a perspective view of a battery module in which a top plate is removed, according to a seventh modification; and

FIG. 16 is a perspective view of a dispersion member according to the seventh modification.

### DETAILED DESCRIPTION OF THE EXEMPLARY EMBODIMENTS

### Embodiment

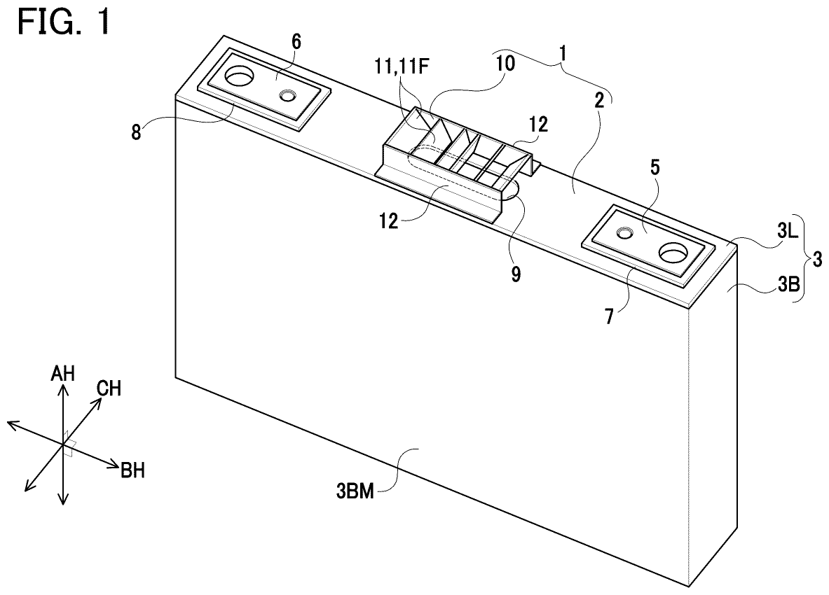

The following description will be made on a change member-equipped battery (which is one example of a change member-equipped power storage device of the present disclosure, hereinafter also simply referred to as an equipped battery) 1, and a battery module (which is one example of a device module of the present disclosure) 30 incorporating the change member-equipped batteries 1, according to an embodiment of the present disclosure, with reference to FIGS. 1 to 8. In the following description, a battery height direction AH, a battery width direction BH, and a battery thickness direction CH of a battery 2 forming the equipped battery 1 are defined as directions shown in FIG. 1. The battery 2 is a rectangular sealed lithium-ion secondary battery, and the battery module 30 and the change member-equipped battery 1 are mounted in vehicles such as a hybrid car, a plug-in hybrid car, and an electric car, and various kinds of devices.

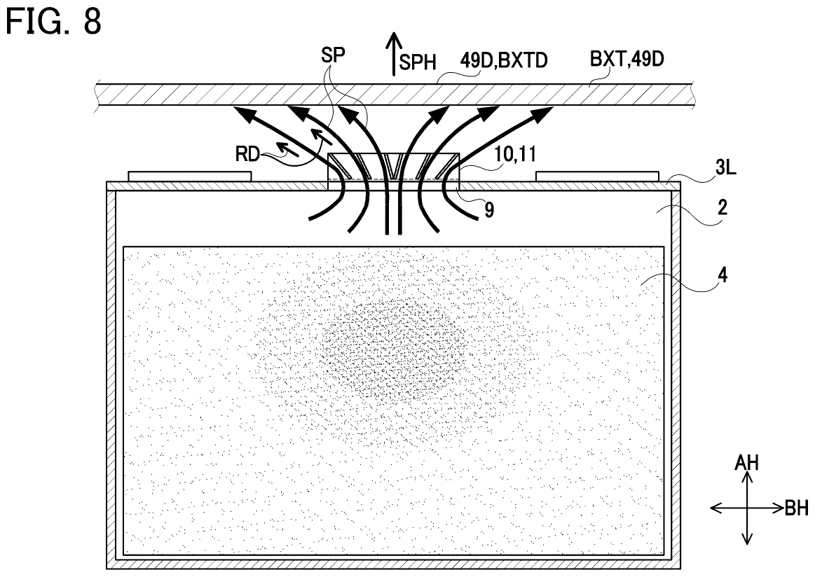

The equipped battery 1 of the present embodiment includes the battery 2, and a dispersion member 10 installed fixedly on the battery 2. The battery 2 includes a case 3, an electrode body 4 (see FIG. 8) housed inside the case 3, a positive terminal 5 and a negative terminal 6 installed fixedly on the case 3, and insulating members 7 and 8 respectively insulating the positive terminal 5 and the negative terminal 6 from the case 3. The electrode body 4 is covered with a bag-shaped insulating film, which is not shown, in the case 3. In addition, the case 3 contains an electrolyte (not shown), a part of which is impregnated in the electrode body 4, and the remaining part is accumulated on a bottom of the case 3.

The case 3 is made of metal (e.g., aluminum in the present embodiment), and includes a bottomed rectangular tube-shaped case body 3B having an opening on one side (i.e., an upper side in FIG. 1) in the battery height direction AH, and a rectangular plate-shaped lid 3L welded to the case body 3B, closing the opening of the case body 3B.

Near an end on one side (a right side in FIG. 1) in the battery width direction BH of the lid 3L, the positive terminal 5 made of an aluminum material and extending from the case 3 to the outside by penetrating the lid 3L is installed fixedly on the lid 3L while being insulated from the lid 3L via the insulating member 7. The positive terminal 5 is connected and conducted to the electrode body 4 in the case 3.

Near an end on the other side (a left side in FIG. 1) in the battery width direction BH of the lid 3L, the negative terminal 6 made of a copper material and extending from the case 3 to the outside by penetrating the lid 3L is installed fixedly on the lid 3L while being insulated from the lid 3L via the negative electrode insulating member 8. The negative terminal 6 is connected and conducted to the electrode body 4 in the case 3.

Each of the insulating members 7 and 8 is made of an insulating resin, specifically, PFA in the present embodiment. As the insulating resin material forming the insulating members 7 and 8, an appropriate insulating resin, such as PE, PP, or PPS, can be used, as well as a fluorine resin, such as the above PFA.

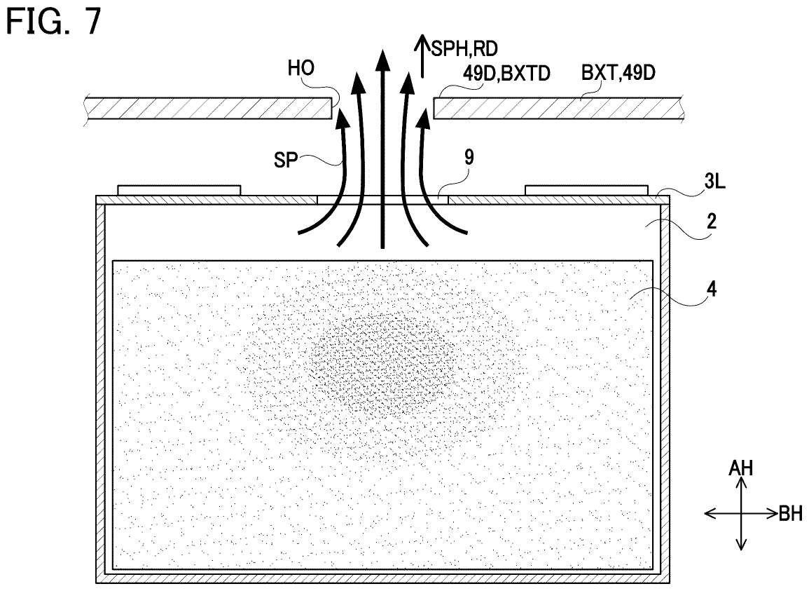

A rupture safety valve 9, which can rupture and open when the internal pressure of the case 3 exceeds a valve opening pressure, is provided in the lid (which is one example of a case wall part of the present disclosure) 3L around the center in the battery width direction BH. In the present embodiment, the safety valve 9 has an elliptic shape long in the battery width direction BH in a plan view, and includes a thin part 9S thinner than the lid 3L. A further thinner center groove part 9G is formed in a V-groove shape at the center in the battery width direction BH of the elliptic shaped thin part 9S, and the safety valve 9 starts rupturing from the center groove part 9G of the thin part 9S and opens when the internal pressure exceeds the valve opening pressure due to an abnormality in the battery 2. At this time, an ejection SP, such as high-temperature gas, is ejected out of the battery through the safety valve 9 toward an ejection direction SPH. Specifically, the ejection SP is ejected in the ejection direction SPH almost corresponding to the battery height direction AH perpendicular to the lid 3L (see FIG. 7), while being concentrated or converged in a narrow range in a beam, or stream, form, such as an approximately cylindrical shape or a circular truncated cone shape with a small diameter, which radially increases toward an end far from the safety valve 9.

The electrode body 4 housed in the case 3 is a so-called flat wound electrode body, formed in a flat shape by pressing in the battery thickness direction CH, in which a strip-shaped positive electrode plate and a strip-shaped negative electrode plate, both not shown, are wound with a pair of strip-shaped separators interposed therebetween. The electrode body 4 is housed in the case 3 such that the electrode body 4 is laid sideways, that is, such that the winding axis extends in the battery width direction BH (see FIGS. 7 and 8).

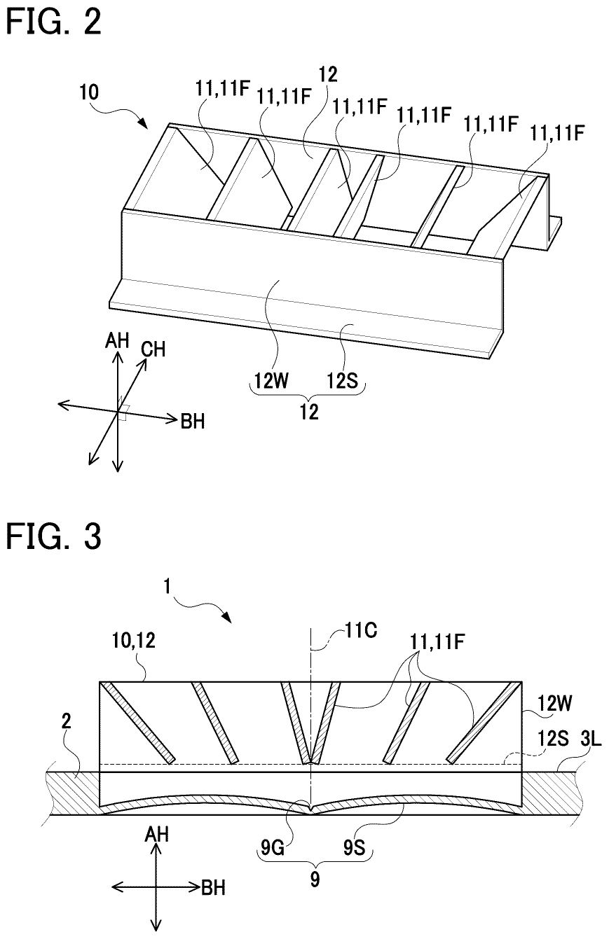

On the other hand, the dispersion member 10 (which is one example of a change member of the present disclosure, see FIGS. 2 and 3) is placed in the form of covering the safety valve 9 from the battery height direction AH, and is installed fixedly on the lid 3L of the case 3. The dispersion member 10 includes a dispersion part 11, and retaining members 12 retaining the dispersion part 11. In the present embodiment, both the dispersion part 11 and the retaining members 12 included in the dispersion member 10 are made of iron in consideration of heat resistance. Thus, as described below, even when the ejection SP ejected out through the safety valve 9 impinges on the dispersion part 11, the dispersion part 11 does not melt and allows an advancing direction RD of the ejection SP to be reliably changed, thus continuing dispersion of the advancing direction RD. The same applies to dispersion members or change members 110 to 710 in first to seventh modifications described below.

As shown in FIGS. 2 and 3, the dispersion part 11 consists of a plurality of flat plate-shaped fins 11F extending in the battery thickness direction CH perpendicular to the sheet of FIG. 3. The fins 11F are arranged symmetrical in the battery width direction BH with respect to the center 11C in the battery width direction BH and inclined such that an upper side of each fin 11F in the battery height direction AH (i.e., a side far from the safety valve 9) is located more outside in the battery width direction BH than a lower side thereof. However, the fins 11F are arranged such that the fins 11F located more outside in the battery width direction BH relative to the center 11C are inclined at smaller angles. Furthermore, the dispersion part 11 is located between the safety valve 9 and an ejection direction portion 49D of a top plate 49 described below. Accordingly, the dispersion part 11 changes the advancing direction RD of at least a part of the ejection SP (all of the ejection SP in the present embodiment) ejected from the safety valve 9 in the ejection direction SPH, to directions toward both outer sides in the battery width direction BH from the center 11C.

When no dispersion part 11 is provided in the battery 2, as shown in FIG. 7, the ejection SP is ejected out through the safety valve 9 and advances toward the ejection direction SPH while concentrating in a beam shape. However, the foregoing configuration including the dispersion part 11 of the present embodiment can change the advancing direction RD of at least a part of the ejection SP (all of the ejection SP in the present embodiment) from the ejection direction SPH, reducing the amount of the ejection SP advancing toward the ejection direction portion 49D.

Furthermore, the dispersion part 11 is configured to disperse the advancing direction RD of the ejection SP. Specifically, the dispersion part 11 changes the advancing direction RD of at least a part of the ejection SP to widen a range of the direction in which the ejection SP advances (see FIG. 8), compared to a range of the ejection direction SPH in which the ejection SP from the safety valve 9 advances when no dispersion part 11 is provided.

In addition, the dispersion part 11 includes the fins (which is one example of a multipath forming member of the present disclosure) 11F for dividedly guiding the ejection SP emerging from the safety valve 9 into a plurality of the advancing directions RD. Thus, the advancing direction RD of the ejection SP can be reliably dispersed (see FIG. 8).

On the other hand, the retaining members 12 each include a plate-shaped standing wall part 12W which retains the fins 11F of the dispersion part 11 and extends in the battery height direction AH, and a support part 12S which is bent in an L shape from the standing wall part 12W and extends along the lid 3L. In the present embodiment, each support part 12S is fixed (ultrasonic welded in the present embodiment) to the lid 3L, and thus the dispersion member 10 is installed fixedly on the lid 3L.

As described above, the dispersion member 10 is provided integrally with the battery 2 in the equipped battery 1 of the present embodiment. Thus, when the safety valve 9 opens, the advancing direction RD of a part or all of the ejection SP ejected toward the ejection direction SPH from the safety valve 9 can be changed, so that the ejection SP can be suppressed or prevented from concentratedly advancing in the ejection direction SPH.

Furthermore, since the advancing direction RD of the ejection SP is dispersed by the dispersion part 11 as described above, thermal influence on a portion on which the ejection SP has impinged can be further reduced. Thus, occurrence of defects such as a hole which is made in a member on which the ejection SP has impinged can be further suppressed reliably.

Furthermore, since the dispersion member 10 is provided integrally with the battery 2 in the equipped battery 1, a direction change part can always be placed in an appropriate position in relation to the battery 2 and the safety valve 9.

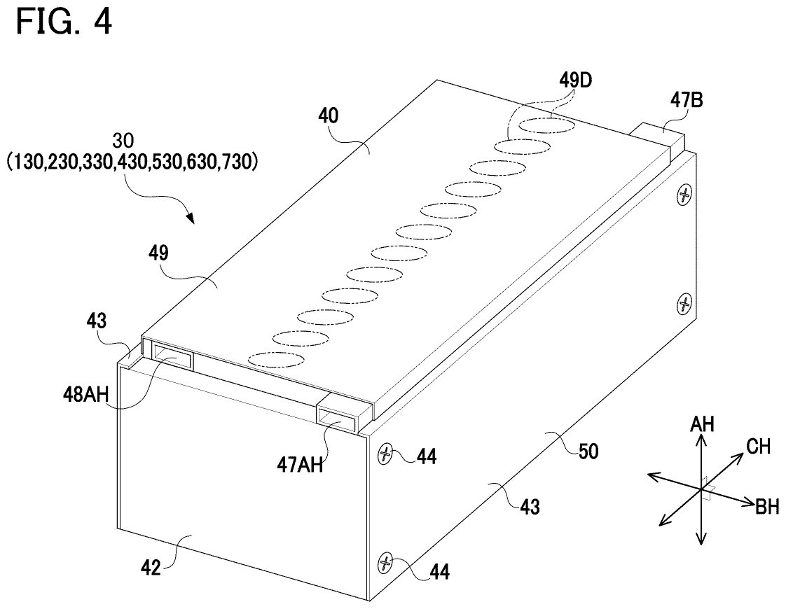

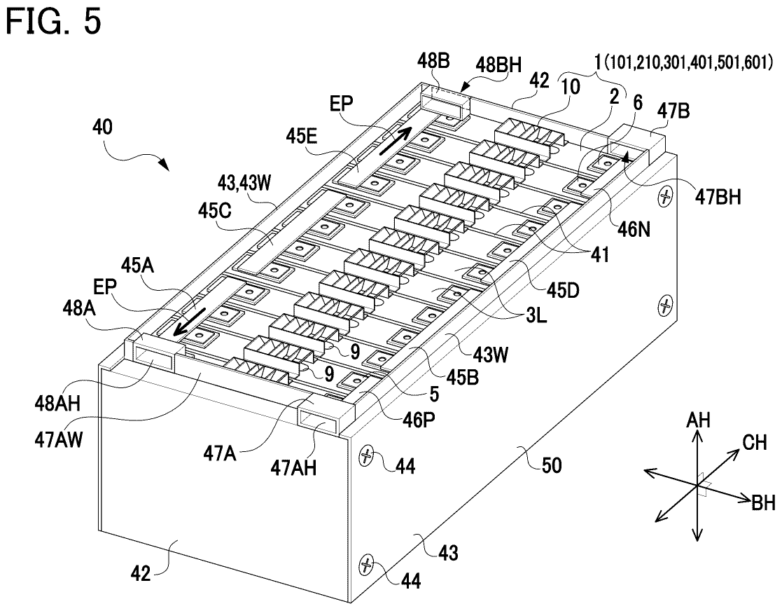

Next, the battery module 30 will be described (see FIGS. 4 and 5). FIG. 5 shows the battery module 30 with the top plate 49 removed from the state shown in FIG. 4. The battery module 30 includes a plurality of equipped batteries 1 (twelve equipped batteries 1 in the present embodiment), and a module structure 40 integrated with these equipped batteries 1. The equipped batteries 1 and plate-shaped spacers 41 are stacked alternately in the battery thickness direction CH, and held between a pair of end plates 42, to which a pair of side plates 43 extending between the end plates 42 are secured with stop screws 44, forming a laminated unit 50. In the laminated unit 50, the safety valves 9 and the dispersion members 10 of the batteries 2 are arranged side by side in the battery thickness direction CH.

In this battery module 30, the equipped batteries 1 in which the dispersion members 10 including the dispersion parts 11 are provided integrally with the batteries 2, so that each dispersion part 11 can always be placed at an appropriate position in relation to the battery 2 and the safety valve 9.

In the laminated unit 50 of the present embodiment, a circuit configuration is made up such that the positive terminals 5 and the negative terminals 6 of the batteries 2 are interconnected by using tie-bars 45A to 45E, a general positive terminal plate 46P, and a general negative terminal plate 46N, and the batteries 2 are connected so that six sets of two batteries 2 connected in parallel are connected in series. The general positive terminal plate 46P is connected to an external device through an opening 47AH of a rectangular tube-shaped terminal connection port member 47A located on one side (a lower left side in FIG. 5) in the battery thickness direction CH. In addition, the general negative terminal plate 46N is connected to the external equipment through an opening 47BH of a rectangular tube-shaped terminal connection port member 47B located on the other side (an upper right side in FIG. 5) in the battery thickness direction CH.

In the battery module 30 of the present embodiment, the module structure 40 is a member integrated with the equipped batteries 1, forming the battery module 30 in combination with the equipped batteries 1. Specifically, the module structure 40 includes the spacers 41, the end plates 42, the side plates 43, the stop screws 44, the tie-bars 45A to 45E, the general positive terminal plate 46P, the general negative terminal plate 46N, the terminal connection port members 47A and 47B, gas discharge port members 48A and 48B, and the top plate 49, as described above.

In the battery module 30 of the present embodiment, when the safety valve 9 of any battery 2 opens, gas and the like are ejected into a discharge path EP, which is a space surrounded by the lids 3L of the batteries 2, the spacers 41, standing wall parts 43W of the side plates 43, standing wall parts 47AW and 47BW respectively extending from the terminal connection port members 47A and 47B in the battery width direction BH, and the top plate 49. Such gas and the like can be discharged to the outside through a gas discharge port 48AH of the rectangular tube-shaped gas discharge port member 48A, which is placed on the one side (the lower left side in FIG. 5) in the battery thickness direction CH, and a gas discharge port 48BH of the rectangular tube-shaped gas discharge port member 48B, which is placed on the other side (the upper right side in FIG. 5) in the battery thickness direction CH.

In the battery module 30 of the present embodiment, the top plate 49 made of aluminum includes a plurality of ejection direction portions 49D (twelve ejection direction portions 49D in the present embodiment), each of which is surrounded and indicated by a broken line in FIG. 4. Each ejection direction portion 49D is located at a destination in the ejection direction SPH in which the ejection SP is ejected out from through the safety valve 9 when the safety valve 9 opens. Furthermore, the ejection direction portions 49D confront, or directly face, the corresponding safety valves 9.

Thus, in a case where no dispersion part 11 is provided between the battery 2 and the top plate 49 as shown in FIG. 7, when the safety valve 9 opens, the ejection SP ejected in a beam shape concentrated in the ejection direction SPH continues to impinge on the ejection direction portion 49D of the top plate 49. This may make a hole in the ejection direction portion 49D, allowing the ejection SP to be ejected out of the battery module 30 through the hole, and may thermally deform the ejection direction portion 49D and its surrounding in the top plate 49. In particular, the ejection direction portions 49D respectively face the safety valves 9 of the batteries 2. Thus, when no dispersion part 11 is provided, the ejection direction SPH is approximately perpendicular to the ejection direction portion 49D and the ejection SP will impinge on the ejection direction portion 49D head-on. This likely causes a hole to be made in the ejection direction portion 49D, and other defects.

Meanwhile, in the battery module 30 of the present embodiment, the above-described dispersion member 10 is provided between each safety valve 9 and each ejection direction portion 49D of the top plate 49. Thus, even when the safety valve 9 opens, the advancing direction RD of at least a part of the ejection SP (all of the ejection SP in the present embodiment) ejected toward the ejection direction SPH from the safety valve 9 is changed by the dispersion part 11 of the dispersion member 10, so that the ejection SP can be suppressed or prevented from concentratedly impinging on the ejection direction portion 49D. This configuration can thus suppress such defects that a hole is made in the ejection direction portion 49D by the ejection SP, allowing the ejection SP to be ejected outside, or the top plate 49 is thermally deformed.

### Nail Penetration Test in Example and Comparative Example

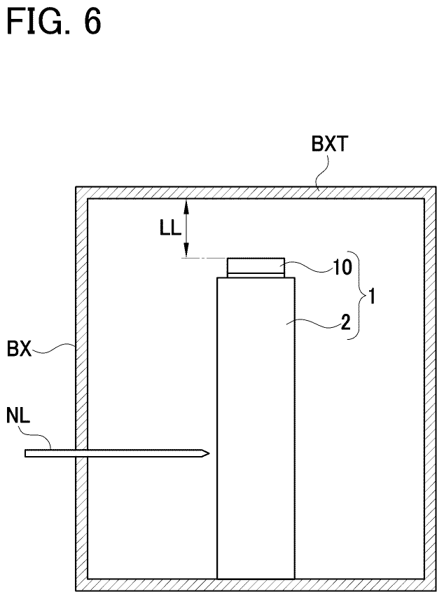

To confirm the effects obtained by providing the dispersion part 11 in the battery module 30 of the present embodiment, a nail penetration test of the battery 2 was performed as follows (see FIG. 6).

First, a storage box BX made of an aluminum plate having a thickness of 3 mm was produced in imitation of the module structure 40. The battery 2 (Comparative Example) having a capacity of 50 Ah, or the equipped battery 1 (Example) in which the dispersion member 10 was welded to the battery 2, was disposed in the storage box BX. The dispersion member 10 was made of an iron plate having a thickness of 0.5 mm. In addition, a distance LL from the dispersion member 10 to a ceiling BXT of the storage box BX is set as LL=10 mm.

For each of the batteries 2 of the Comparative example and the Example, charged with a constant-voltage charge to a battery voltage of about 4.2 V, a nail NL having a diameter of 3 mm was pierced at a speed of 1 mm/s in the center of a long-side surface wall part 3BM of each battery 2 to cause thermal runway in each battery 2, thereby generating gas and causing the safety valve 9 to open. Then, it was observed as to whether a hole (cleavage) was generated in the ceiling BXT of the storage box BX due to the ejection SP having been ejected for approximately 30 seconds or not.

### Comparative Example

In Comparative Example using the battery 2 including no dispersion member 10 as shown in FIG. 7, a hole HO was generated in the ceiling BXT of the storage box BX made of aluminum, and the ejection SP was ejected out of the storage box BX through the hole HO. It is inferred that, since the high-temperature ejection SP was ejected in a beam shape concentrated in a narrow range from the safety valve 9 toward the ejection direction SPH, the ejection SP concentratedly impinges on a confronting portion BXTD of the ceiling BXT, which confronts the safety valve 9, and thus the hole HO was generated.

### Example

In contrast, in Example using the equipped battery 1 in which the dispersion member 10 was fixed to the battery 2, as shown in FIG. 8, no hole HO was generated in the ceiling BXT and also no ejection SP was ejected out of the storage box BX. This is presumably because the ejection SP was ejected out through the safety valve 9 and advanced in the ejection direction SPH, and the advancing direction RD of at least a part of the ejection SP (all of the ejection SP in this example) was changed from the ejection direction SPH by the dispersion part 11 of the dispersion member 10, so that the amount of the ejection SP advancing toward the ceiling BXT could be reduced and, furthermore, the range of the direction in which the ejection SP advanced was widened. Thus, the effects obtained by providing the dispersion part 11 in the battery module 30 were confirmed.

In the above-described embodiment, the fins 11F of the dispersion part 11 of the dispersion member 10 provided in the equipped battery 1 used for the battery module 30 are arranged in such a configuration as shown in FIG. 3.

However, the arrangement configuration may be modified as below. In the following description, different parts will be mainly described and identical or similar parts to those in the above are omitted.

### First Modification

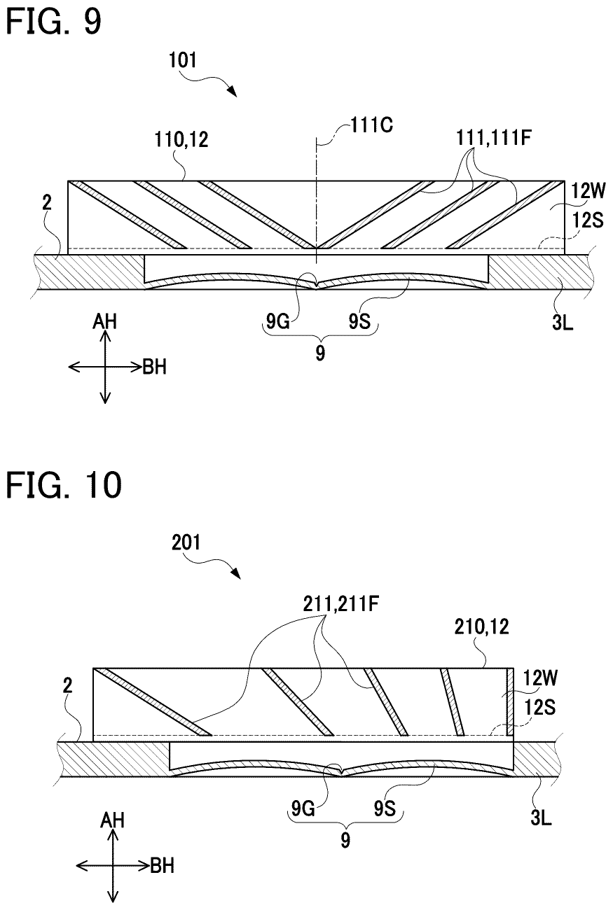

For example, in a change member-equipped battery 101 used for a battery module 130 of a first modification, fins 111F of a dispersion part 111 of the dispersion member 110 fixed to the battery 2 are arranged in such a configuration as shown in FIG. 9. The retaining members 12 of the dispersion member 110 are identical to those in the embodiment, and therefore the description thereof is omitted. The same applies to those in the following second to fifth modifications.

The dispersion part 111 of the present first modification also includes the plate-shaped fins 111F extending in the battery thickness direction CH. In addition, the fins 111F are arranged symmetrically in the battery width direction BH with respect to the center 111C in the battery width direction BH and inclined such that an upper side of each fin 111F in the battery height direction AH (i.e., a side far from the safety valve 9) is located more outside in the battery width direction BH than a lower side thereof. However, unlike the dispersion part 11 of the foregoing embodiment, the fins 111F are inclined at the same angle. The dispersion part 111 is also located between the safety valve 9 and the ejection direction portion 49D of the top plate 49. Accordingly, the dispersion part 111 changes the advancing direction RD of at least a part of the ejection SP ejected out through the safety valve 9 in the ejection direction SPH into directions from the center 111C toward both outer sides in the battery width direction BH. In addition, the advancing direction RD of the ejection SP can be dispersed in the battery width direction BH. Furthermore, the fins 111F can dividedly guide the ejection SP into a plurality of advancing directions RD, whereby the advancing direction RD of the ejection SP can be reliably dispersed.

### Second Modification

For example, in a change member-equipped battery 201 used for a battery module 230 of a second modification, fins 211F of a dispersion part 211 of the dispersion member 210 fixed to the battery 2 are arranged in such a configuration shown in FIG. 10.

The dispersion part 211 of this second modification also includes the plate-shaped fins 211F extending in the battery thickness direction CH. In this arrangement configuration, the fins 211F located toward one side (a left side in FIG. 10) in the battery width direction BH are inclined at smaller angles so that the upper ends of the fins 211F on an upper side in the battery height direction AH (i.e., a side far from the safety valve 9) are located toward the one side than lower ends thereof. The dispersion part 211 is also located between the safety valve 9 and the ejection direction portion 49D of the top plate 49. Accordingly, with the dispersion part 211, the advancing direction RD of at least a part of the ejection SP ejected in the ejection direction SPH from the safety valve 9 is changed so as to head to the one side (the left side in FIG. 10) in the battery width direction BH. In addition, the advancing direction RD of the ejection SP can be dispersed to the one side in the battery width direction BH. Further, the respective fins 211F can dividedly guide the ejection SP into a plurality of advancing directions RD, whereby the advancing direction RD of the ejection SP can be reliably dispersed.

### Third Modification

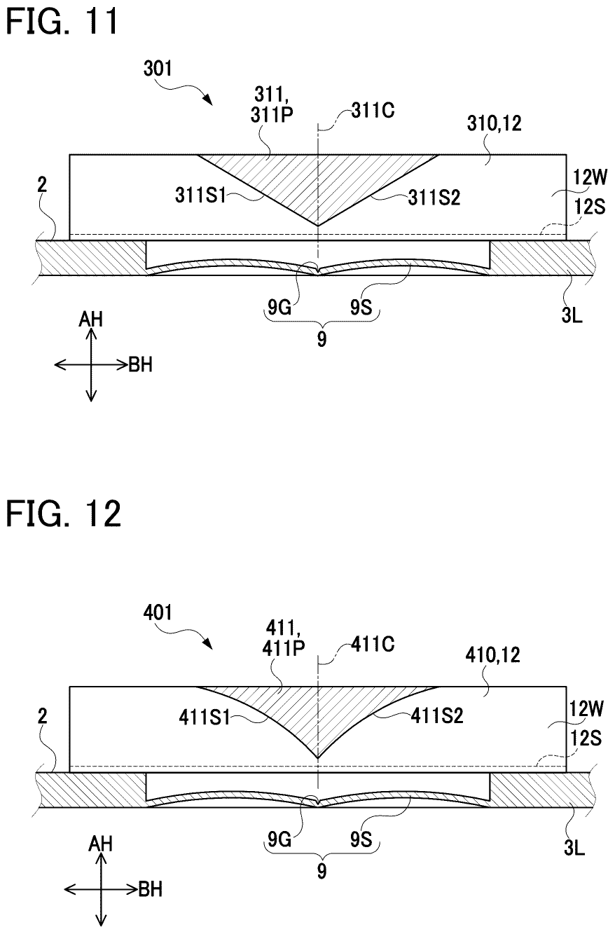

In the foregoing embodiment and the first and second modifications, the dispersion parts 11, 111, and 211 respectively include the plate-shaped fins 11F, 111F, and 211F. In contrast, in a third modification, instead of the fins, a dispersion part 311 includes a convex member 311P extending in the battery thickness direction CH and protruding downward in FIG. 11 (toward a side closer to the safety valve 9) in the battery height direction AH (see FIG. 11). That is, in a change member-equipped battery 301 used for a battery module 330 of the present third modification, the dispersion part 311 of the dispersion member 310 fixed to the battery 2 is composed of the convex member 311P shown in FIG. 11.

As shown in FIG. 11, the convex member 311P has a cross-sectional shape that is an isosceles triangle shape symmetrical in the battery width direction BH with respect to the center 311C in the battery width direction BH, and protruding downward in FIG. 11 (the side closer to the safety valve 9) in the battery height direction AH. Thus, the convex member 311P includes, as shown in FIG. 11, a first slope 311S1 composed of a flat surface which faces the lower left and extends in the battery thickness direction CH (a direction perpendicular to the sheet), and a second slope 311S2 composed of a flat surface which faces the lower right and extends in the battery thickness direction CH. The dispersion part 311 is also located between the safety valve 9 and the ejection direction portion 49D of the top plate 49. Accordingly, with the dispersion part 311, the advancing direction RD of the ejection SP ejected in the ejection direction SPH from the safety valve 9 can be changed so as to head to both outer sides in the battery width direction BH with respect to the center 311C. In addition, the advancing direction RD of the ejection SP can be dispersed into two directions in the battery width direction BH.

### Fourth Modification

In the foregoing third modification, the convex member 311P used for the dispersion part 311 has a triangular cross-sectional shape, but may be of another cross-sectional shape. That is, in a present fourth modification, a convex member 411P used for a dispersion part 411 has such a cross-sectional shape as shown in FIG. 12. That is, in a change member-equipped battery 401 used for a battery module 430 of the present fourth modification, the dispersion part 411 of the dispersion member 410 fixed to the battery 2 is composed of the convex member 411P shown in FIG. 12.

As shown in FIG. 12, the convex member 411P has a cross-sectional shape that is an approximately triangle shape symmetrical in the battery width direction BH with respect to the center 411C in the battery width direction BH, and protruding downward in FIG. 12 (the side closer to the safety valve 9) in the battery height direction AH. However, unlike the convex member 311P of the third modification, in FIG. 12, a first slope 411S1 facing the lower left and extending in the battery thickness direction CH, and a second slope 411S2 facing the lower right and extending in the battery thickness direction CH, each have a concave shape recessed inward. The dispersion part 411 is also located between the safety valve 9 and the ejection direction portion 49D of the top plate 49. With the dispersion part 411, the advancing direction RD of the ejection SP ejected in the ejection direction SPH from the safety valve 9 can be changed so as to head to both outer sides in the battery width direction BH with respect to the center 411C. In addition, the advancing direction RD of the ejection SP can be dispersed into two directions in the battery width direction BH.

### Fifth Modification

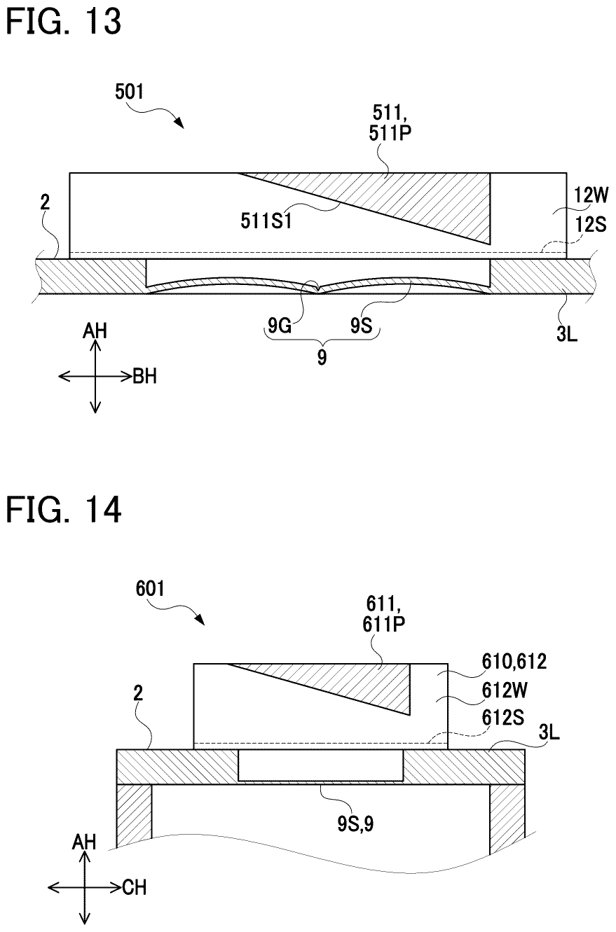

In the foregoing third modification, the convex member 311P used for the dispersion part 311 has an isosceles triangular cross-sectional shape symmetrical with respect to the center 311C in the battery width direction BH (bilaterally symmetrical in FIG. 11) and protruding downward in FIG. 11 in the battery height direction AH. In a present fifth modification, unlike the third modification, a convex member 511P used for a direction change part 511 has such a right-angled triangular cross-sectional shape as shown in FIG. 13. That is, in a change member-equipped battery 501 used for a battery module 530 of the present fifth modification, a direction change part 511 of the change member 510 fixed to the battery 2 is composed of a convex member 511P shown in FIG. 13.

Specifically, the convex member 511P has a cross-sectional shape that is a right-angled triangle shape having a hypotenuse directed upward (toward a side far from the safety valve 9) in the battery height direction AH as it advances along one side (a left side in FIG. 13) of the battery width direction BH. The convex member 511P includes a first slope 511S1 facing the lower left in FIG.

13 and extending in the battery thickness direction CH to form the hypotenuse of the right-angled triangle. The direction change part 511 is also located between the safety valve 9 and the ejection direction portion 49D of the top plate 49.

With the direction change part 511, the advancing direction RD of at least a part of the ejection SP ejected in the ejection direction SPH from the safety valve 9 is changed so as to head to the one side (the left side in FIG. 13) in the battery width direction BH.

### Sixth Modification

The foregoing embodiment and the first to fifth modifications exemplify that the dispersion part 11 and others are configured to change the advancing direction RD of at least a part of the ejection SP ejected in the ejection direction SPH from the safety valve 9 to the battery width direction BH.

However, the advancing direction RD can also be changed to not only the battery width direction BH but also another direction, that is, the battery thickness direction CH, or the battery width direction BH and the battery thickness direction CH. In a present sixth modification, with the direction change part 611, the advancing direction RD of at least a part of the ejection SP ejected in the ejection direction SPH from the safety valve 9 is changed so as to head to one side (a left side in FIG. 14) in the battery thickness direction CH. That is, in a change member-equipped battery 601 used for a battery module 630 of the present sixth modification, the direction change part 611 of the change member 610 fixed to the battery 2 is formed as shown in FIG. 14, using a convex member 611P having a right-angled triangular cross-sectional shape, similar to the convex member 511P of the fifth modification.

Specifically, the convex member 611P has a right-angled triangular cross-sectional shape in which a hypotenuse is directed upward (toward a side far from the safety valve 9) in the battery height direction AH as it advances along the one side (the left side in FIG. 14) of the battery thickness direction CH. The convex member 611P includes a first slope 611S1 facing the lower left in FIG. 14 and extending in the battery width direction BH (direction perpendicular to the sheet) to form the hypotenuse of this right-angled triangle. The direction change part 611 is also located between the safety valve 9 and the ejection direction portion 49D of the top plate 49. With the direction change part 611, the advancing direction RD of at least a part of the ejection SP ejected in the ejection direction SPH from the safety valve 9 is changed so as to head to the one side (left side in FIG. 14) in the battery thickness direction CH.

In contrast, similar to the retaining members 12 of the dispersion member 10 of the embodiment, retaining members 612 each include a plate-shaped standing wall part 612W which retains the convex member 611P forming the direction change part 611 and extends in the battery height direction AH, and a support part 612S which is bent in an L shape from the standing wall part 612W and extends along the lid 3L. Also, in the present sixth modification, the change member 610 is installed fixedly on the lid 3L by fixing the support part 612S to the lid 3L.

The sixth modification exemplifies that the direction change part 611 is composed of the convex member 611P having a right-angled triangle-shaped cross section. As an alternative, it may be composed of fins in a cross-sectional arrangement configuration similar to that of the fins 11F to 211F shown in the embodiment and the first and second modifications. Alternatively, a convex member having a cross sectional shape similar to those of the convex members 311P, 411P shown in the third and fourth modifications can also be used.

### Seventh Modification

The foregoing embodiment and the first to sixth modifications exemplify that the dispersion members 10 to 410 including the dispersion parts 11 to 411, or the change members 510, 610 including the direction change parts 511, 611 are fixed to the lids 3L of the batteries 2 to form the change member-equipped batteries 1 to 601, and the equipped batteries 1 to 601 are incorporated in the battery modules 30 to 630 (see FIGS. 4 and 5).

However, the dispersion member or the change member need not be fixed to the battery, and, in the battery module 30 or the like, a dispersion part or a direction change part for changing the advancing direction RD of at least a part of the ejection SP may be located between the safety valve 9 of each battery 2 and the ejection direction portion 49D of the top plate 49.

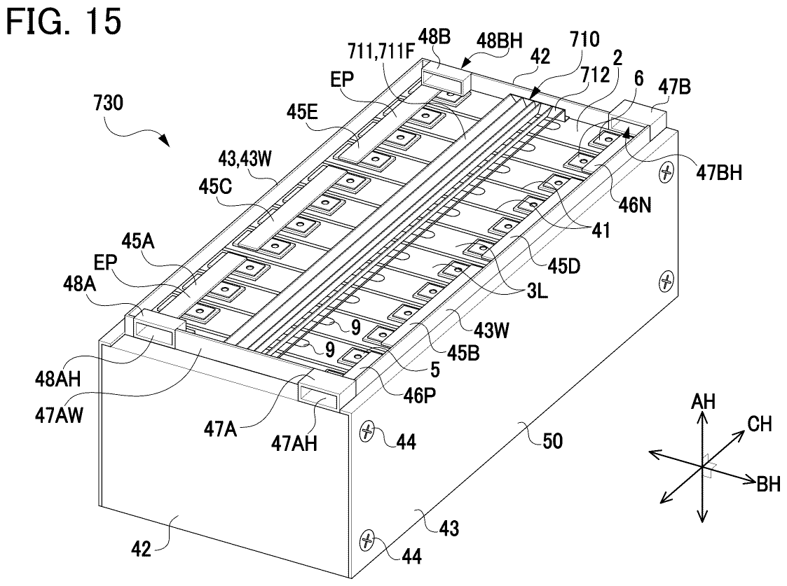

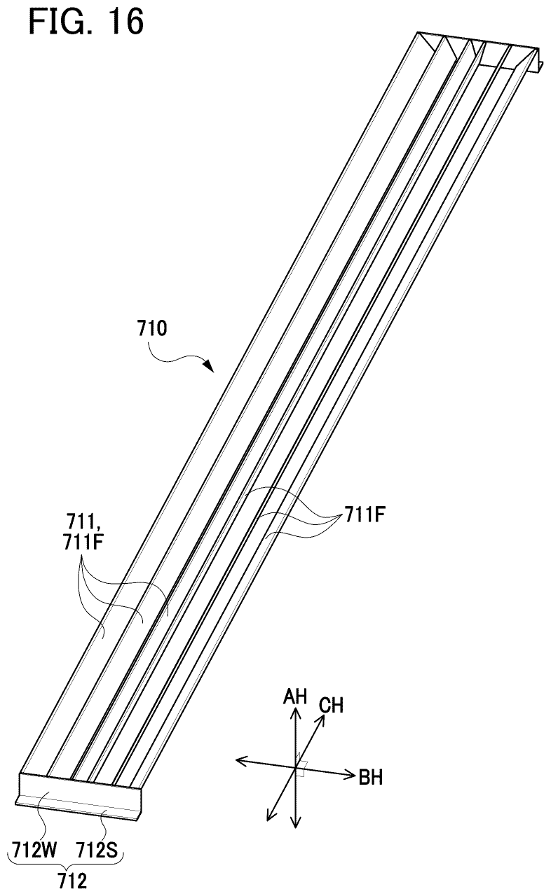

For example, specifically, as in a battery module 730 of a seventh modification shown in FIG. 15, the dispersion member 710 used commonly for the plurality of batteries 2 maybe located between each battery 2 and the top plate 49. The dispersion member 710 shown in FIGS. 15 and 16 has a long shape extending in the battery thickness direction CH, and is placed in the form of covering the safety valves 9 of all (twelve) batteries 2 from above in the battery height direction AH. The battery module 730 of the seventh modification is different from the battery module 30 using the batteries 2 to which the dispersion members 10 are fixed, in a way that the batteries 2 and the above dispersion member 710 are used and no dispersion member 10 is used. Therefore, identical or similar parts to those of the battery module 30 are assigned the same reference signs as above and the description thereof is omitted.

The dispersion member 710 includes a dispersion part 711, and retaining members 712 retaining the dispersion part 711, and has a cross-sectional shape similar to that of the dispersion member 10 of the above-described embodiment (see FIG. 3). That is, as shown in FIG. 16, the dispersion part 711 includes a plurality of plate-shaped fins 711F extending in the battery thickness direction CH. The fins 711F are arranged symmetrical in the battery width direction BH with respect to the center in the battery width direction BH of the dispersion part 711, and inclined such that an upper side of each fin 711F in the battery height direction AH is located more outside in the battery width direction BH than a lower side thereof. However, the fins 711F are arranged such that the fins 711F located more outside in the battery width direction BH relative to the center are inclined at smaller angles. Furthermore, the dispersion part 711 is located between the safety valves 9 of the batteries 2 and the ejection direction portions 49D of the top plate 49. Accordingly, with the dispersion part 711, the advancing direction RD of at least a part of the ejection SP (all of the ejection SP in the present seventh modification) ejected in the ejection direction SPH from the safety valve 9 can be changed so as to head to both outer sides from the center in the battery width direction BH. In addition, the advancing direction RD of the ejection SP can be dispersed in the battery width direction BH. Further, the respective fins 711F can dividedly guide the ejection SP into a plurality advancing directions RD, whereby the advancing direction RD of the ejection SP can be reliably dispersed.

The dispersion member 710 is connected to the standing wall parts 47AW and 47BW respectively extending from the terminal connection port members 47A and 47B in the battery width direction BH, by use of the support parts 712S of the retaining members 712, to be integrated with the battery module 730, even though the details thereof are not described.

While the present disclosure has been described above based on the embodiment and the first to seventh modifications, it should be understood that the present disclosure is not limited to the embodiment, etc., but can be applied with modifications appropriately made thereto without departing from the scope of the gist of the present disclosure.

For example, in the foregoing embodiment and first to sixth modifications, the dispersion members having the same form are used, as the dispersion members respectively fixed to the plurality of batteries 2 used for the battery module 30 or the like.

However, considering the relationship between the position of each battery 2 in the battery thickness direction CH and the positions of the gas discharge ports 48AH and 48BH in the battery module, a plurality of kinds of dispersion members including fins, convex members, or the like, which have different shapes, of the dispersion parts are produced in advance such that the advancing direction RD of the ejection SP, such as gas, is directed in an appropriate direction, and a different dispersion member may be fixed according to the position of each battery 2 in the battery thickness direction CH.

Alternatively, in a dispersion member configured for the plurality of batteries 2, similar to the dispersion member 710 of the seventh modification, shapes of fins, a convex member, or the like may be set different such that the advancing direction RD of the ejection SP, such as gas, for each battery 2 is different from each other.

In addition, the foregoing embodiment and first to seventh modifications exemplify that the dispersion parts or the direction change parts 11 to 711 included in the dispersion members or the change members 10 to 710 are made of iron.

However, ejection duration of the ejection SP being ejected out through the safety valve 9 is limited. For example, in the embodiment and others using the batteries 2 configured as above the ejection duration is approximately 30 seconds as described above. On the other hand, in some cases, the dispersion part of the dispersion member or the direction change part of the change member in the entirety need not remain after ejection of the ejection SP has been completed. In this case, the material (material having a low heat-resistant temperature, e.g., aluminum or plastic) or the dimensions such as a thickness, of the dispersion part of the dispersion member or the like, may be selected such that the dispersion part of the dispersion member or the like has heat-resisting properties capable of enduring the ejection SP over a certain length of the front stage of the ejection duration, calculated backward from the period of time during which the ejection direction portion (ejection direction portion 49D of the top plate 49) and the like can endure the temperature of the ejection SP.

### REFERENCE SIGNS LIST

1, 101, 201, 301, 401, 501, 601 Change member-equipped battery (Change member-equipped power storage device)
2 Battery (Power storage device)
3 Case (Metal case)
3L Lid (Case wall part)
9 Safety valve
9S Thin part
9G Center groove part
10, 110, 210, 310, 410, 710 Dispersion member (Change member)
510, 610 Change member
11, 111, 211, 311, 411, 711 Dispersion part (Direction change part)
511, 611 Direction change part

### 11C, 111C, 311C, 411C Center

11F, 111F, 211F, 711F Fin (Multipath forming member)
311P, 411P Convex member (Multipath forming member)
511P, 611P Convex member
311S1, 411S1, 511S1, 611S1 First slope
311S2, 411S2 Second slope
12, 612, 712 Retaining member
12W, 612W Standing wall part
12S, 612S Support part
30, 130, 230, 330, 430, 530, 630, 730 Battery module (Device module)
40 Module structure (Structure)
49 Top plate
49D Ejection direction portion (Ejection direction confronting part)
AH Battery height direction
BH Battery width direction
CH Battery thickness direction

### SP Ejection

SPH Ejection direction
RD Advancing direction

What is claimed is:

1. A device module comprising:
a power storage device including a safety valve; and
a structure integrated with the power storage device, the structure including an ejection direction portion located in an ejection direction in which ejection is ejected out through the safety valve when the safety valve opens,
wherein the device module further comprises a direction change part, located between the safety valve and the ejection direction portion, for changing an advancing direction of at least a part of the ejection ejected in the ejection direction from the safety valve.

2. The device module according to claim 1, wherein the direction change part is a dispersion part for dispersing the advancing direction of the ejection.

3. The device module according to claim 2, wherein the dispersion part includes a multipath forming member for dividedly guiding the ejection ejected out through the safety valve into a plurality of advancing directions.

4. The device module according to claim 1, wherein at least a portion, of the direction change part, on which the ejection impinges, is made of a heat-resistant material capable of enduring the temperature of the ejection.

5. The device module according to claim 2, wherein at least a portion, of the direction change part, on which the ejection impinges, is made of a heat-resistant material capable of enduring the temperature of the ejection.

6. The device module according to claim 3, wherein at least a portion, of the direction change part, on which the ejection impinges, is made of a heat-resistant material capable of enduring the temperature of the ejection.

7. The device module according to claim 1, wherein the direction change part is provided integrally with the power storage device in a form of covering the safety valve.

8. The device module according to claim 2, wherein the direction change part is provided integrally with the power storage device in a form of covering the safety valve.

9. The device module according to claim 3, wherein the direction change part is provided integrally with the power storage device in a form of covering the safety valve.

10. The device module according to claim 1, wherein the direction change part is provided integrally with the structure.

11. The device module according to claim 2, wherein the direction change part is provided integrally with the structure.

12. The device module according to claim 3, wherein the direction change part is provided integrally with the structure.

13. The device module according to claim 1, wherein
the power storage device includes a metal case forming a case wall part,
the safety valve is a rupture safety valve formed of a thin part that is a part of the case wall part and configured to open when the thin part ruptures, and
the ejection direction portion is an ejection direction confronting part that confronts the safety valve.

14. The device module according to claim 2, wherein
the power storage device includes a metal case forming a case wall part,
the safety valve is a rupture safety valve formed of a thin part that is a part of the case wall part and configured to open when the thin part ruptures, and
the ejection direction portion is an ejection direction confronting part that confronts the safety valve.

15. The device module according to claim 3, wherein
the power storage device includes a metal case forming a case wall part,
the safety valve is a rupture safety valve formed of a thin part that is a part of the case wall part and configured to open when the thin part ruptures, and
the ejection direction portion is an ejection direction confronting part that confronts the safety valve.

16. A change member-equipped power storage device comprising:
a power storage device including a safety valve; and
a change member integrally provided with the power storage device,
the change member covering the safety valve and forming a direction change part for changing an advancing direction of at least a part of ejection ejected to an ejection direction from the safety valve when the safety valve opens.

17. The change member-equipped power storage device according to claim 16, wherein the direction change part is a dispersion part for dispersing the advancing direction of the ejection.

18. The change member-equipped power storage device according to claim 17, wherein the dispersion part includes a multipath forming member for dividedly guiding the ejection ejected out through the safety valve into a plurality of advancing directions.

19. The change member-equipped power storage device according to claim 16, wherein at least a portion, of the change member, on which the ejection impinges, is made of a heat-resistant material capable of enduring the temperature of the ejection.

20. The change member-equipped power storage device according to claim 17, wherein at least a portion, of the change member, on which the ejection impinges, is made of a heat-resistant material capable of enduring the temperature of the ejection.
